(19) United States
(12) Patent Application Publication
(10) Pub. No.: US 2004/0050293 A1
(43) Pub. Date: Mar. 18, 2004

(54) Ink composition for inkjet recording, ink cartridge, and recording apparatus

(76) Inventors: Hidekazu Arase, Hyogo (JP); Mamoru Soga, Osaka (JP)

Correspondence Address: HARNESS, DICKEY & PIERCE, P.L.C., P.O. BOX 828, BLOOMFIELD HILLS, MI, 48303, US

(21) Appl. No.: 10/649,176

(22) Filed: Aug. 27, 2003

(30) Foreign Application Priority Data
Sep. 10, 2002 (JP) 2002-263850

(51) Int. Cl. C09D 11/00

(52) U.S. Cl. 106/31.27

(57) ABSTRACT

An ink composition containing a colorant, a humectant, water, and a water-soluble substance that is condensation-polymerized in the absence of the water, wherein the water-soluble substance has a hydrophobic group (fluoroalkyl group, alkyl group).

### BACKGROUND OF THE INVENTION

1. Field of the Invention

The present invention falls within the technical field that relates to an ink composition for inkjet recording, an ink cartridge and a recording apparatus which are suitable for inkjet recording.

2. Description of the Prior Art

Conventionally, ink containing a colorant (dye or pigment), a humectant and water has been well known as ink used for inkjet recording. However, in the case of forming an image with the ink on a recording medium, the water-resistivity of the image is a matter of concern, i.e., there is a problem such that the colorant exudes into water when the image is exposed to water. Especially when an image is recorded on plain paper, the water-resistivity of the image is very poor. (The “plain paper” herein refers to paper which is one of various types of commercially-available paper, which is especially used for an electrophotographic copying machine, and which is produced without an intention to have an optimum structure, composition, properties, or the like, for inkjet recording.) In Japanese Unexamined Patent Publication No. 10-212439, Japanese Unexamined Patent Publication No. 11-293167, Japanese Unexamined Patent Publication No. 11-315231, and Japanese Unexamined Patent Publication No. 2001-49160, adding a hydrolyzable silane compound (organic silicon compound) to ink in order to improve the water-resistivity of an image formed with the ink on a recording medium has been proposed. When a drop of such ink containing a silane compound is adhered on a recording medium, and a water content (solvent) of the ink drop evaporates or permeates into the recording medium, the silane compound remaining on the recording medium is condensation-polymerized, and this condensation-polymerized silane compound encloses a colorant. As a result, even when the image formed on the recording medium is exposed to water, the colorant is prevented from exuding into the water.

However, the ink described in the above publications do not have sufficient water-resistivity, so that when an image formed with the ink on a recording medium is exposed to water, the colorant sometimes exudes into the water.

### SUMMARY OF THE INVENTION

The present invention was conceived in view of the above circumstances. An objective of the present invention is to further improve the water-resistivity of an ink composition for inkjet recording which includes a water-soluble substance that is condensation-polymerized in the absence of water.

For the purpose of achieving the above objective, the present inventors carried out exhaustive studies and found that, in the ink disclosed in the above-mentioned patent publications, a colorant (dye) exudes into water because the colorant is not sufficiently enclosed by a silane compound.

This problem is now described with reference to FIG. 6. FIG. 6 schematically shows a network 75 formed by polycondensation of a silane compound (bonds of silicon atoms 71) which encloses an image (colorant) formed on a recording medium 41. (It should be noted that, the network 75 is shown so as to enclose the entire image on the recording medium 41 in FIG. 6, but precisely, the network 75 encloses the colorant which forms the image on the recording medium 41.)

In the case where the silicon atoms 71 of the silane compound are bonded with each other so that the formed network 75 is generally homogeneous, the colorant is entirely enclosed by the network 75. Thus, even when the image is exposed to water, the colorant does not exude out of the network 75.

However, in some cases, the bonds between the silicon atoms 71 are not both sufficiently and surely established. It is estimated that a defective portion 72 occurs in the network 75, at which the silicon atoms 71 are not bonded with each other. Since the silane compound has a hydrophilic group (amino group), a portion surrounding the defective portion 72 becomes hydrophilic. Such a hydrophilic portion readily introduces water 74. As a result, it is understood that, in the case of a conventional ink composition, a colorant exudes out of the network 75 through the defective portion 72.

Especially in the case of an ink composition containing a magenta dye, it was found that the water-resistivity of an image formed with the ink composition was significantly low. This is because the interaction between the magenta dye and the silane compound is weak, and as a result, the defective portion 72 occurs more readily in the network 75 of the silicon atoms 71 as compared with the other dye types.

An ink composition for inkjet recording of the present invention comprises a colorant, a humectant, water, and a water-soluble substance that is condensation-polymerized in the absence of the water. In the ink composition, the water-soluble substance has a hydrophobic group.

In this structure, when the ink composition in the form of an ink drop is adhered onto a recording medium (e.g., paper), the water content of the ink drop evaporates or permeates into the recording medium, whereby the water-soluble substance is condensation-polymerized and the colorant is enclosed by a product of the polycondensation (network). Thus, even when an image formed by the ink drop on the recording medium is exposed to water, the colorant is prevented from exuding into the water, and the water-resistivity of the image is secured.

Since the water-soluble substance has a hydrophobic group, the network itself has hydrophobicity. Thus, the network is impervious to water. Therefore, even when the network has a defective portion, the colorant enclosed by the network is prevented from exuding through the defective portion. As a result, the water-resistivity of the image is greatly improved.

The water-soluble substance may be a hydrolyzate of an amino silane compound and a silicon compound having a hydrophobic group. The amino silane compound is quite preferable in consideration of improvement in the water-resistivity.

The hydrophobic group may be an alkyl group or a fluoroalkyl group. The hydrophobic group(s) may include both an alkyl group and a fluoroalkyl group. A silicon compound including a fluoroalkyl group itself has a significantly low surface tension as compared with other silicon compounds. Thus, when an ink composition contains the silicon compound including a fluoroalkyl group, the surface tension of the ink composition decreases. Thus, the rate of diffusion of an ink drop adhered on the recording medium into the recording medium increases, and the rapid-drying property of the ink improves.

It is preferable that the carbon number of the alkyl group is equal to or greater than 3 and equal to or smaller than 6. This is because the solubility of the water-soluble substance in water deteriorates when the hydrophobic group is an alkyl group having a carbon number of 7 or greater.

It is preferable that the ink composition further contains a penetrant. With this feature, a solvent of the ink composition which contains the humectant, the penetrant and the water quickly permeates into a recording medium (e.g., paper) after an ink drop is adhered on the recording medium. Accordingly, polycondensation of the water-soluble substance is quickly performed, and the water-resistivity of an image is further improved.

It is preferable that the amount of the silicon compound having a hydrophobic group is equal to or higher than 3 mol % and equal to or lower than 17 mol % when calculated on the basis of a silicon atom as a reference. This is because when the amount of the silicon compound is lower than 3 mol %, the above-described effect of improving the water-resistivity of the image cannot be achieved. When the amount of the silicon compound is higher than 17 mol %, the solubility of the water-soluble substance in water can be decreased. More preferably, the amount of the silicon compound having a hydrophobic group is equal to or higher than 5 mol % and equal to or lower than 10 mol %.

An ink cartridge of the present invention comprises an ink composition for inkjet recording, wherein the ink composition contains a colorant, a humectant, water, and a water-soluble substance that is condensation-polymerized in the absence of the water. In this ink cartridge, the water-soluble substance has a hydrophobic group.

A recording apparatus of the present invention comprises an ink composition for inkjet recording, the recording apparatus ejecting the ink composition toward a recording medium, wherein the ink composition contains a colorant, a humectant, water, and a water-soluble substance that is condensation-polymerized in the absence of the water. In this recording apparatus, the water-soluble substance has a hydrophobic group.

### BRIEF DESCRIPTION OF THE DRAWINGS

FIG. 1 is a general perspective view showing an inkjet-type recording apparatus including an ink composition for inkjet recording according to an embodiment of the present invention.

FIG. 2 shows a portion of a bottom surface of an inkjet head of the inkjet-type recording apparatus.

FIG. 3 is a cross-sectional view taken along line III-III of FIG. 2.

FIG. 4 is a cross-sectional view taken along line IV-IV of FIG. 2.

FIG. 5 schematically shows a network which encloses an image (colorant) formed of an ink composition of the present invention on recording paper.

FIG. 6 schematically shows a network which encloses an image (colorant) formed of a conventional ink composition on recording paper.

### DESCRIPTION OF THE PREFERRED EMBODIMENTS

Structure of Recording Apparatus

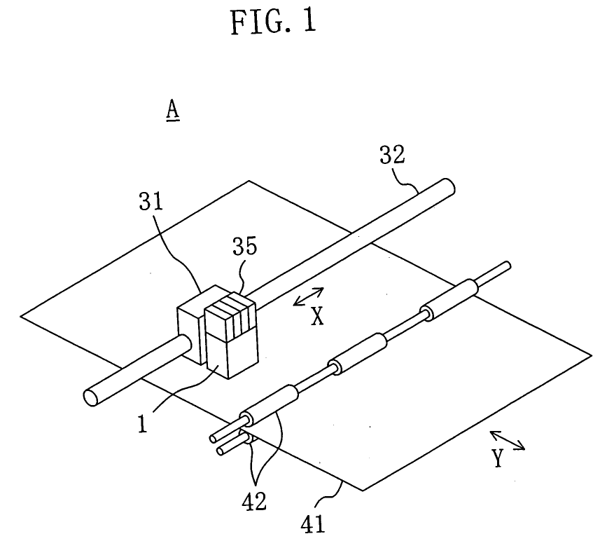

FIG. 1 generally shows an inkjet-type recording apparatus A including an ink composition for inkjet recording according to an embodiment of the present invention. The recording apparatus A has an inkjet head 1. The inkjet head 1 ejects the ink onto recording paper 41 in a manner described later. On the upper surface of the inkjet head 1, an ink cartridge 35 including the ink composition is attached.

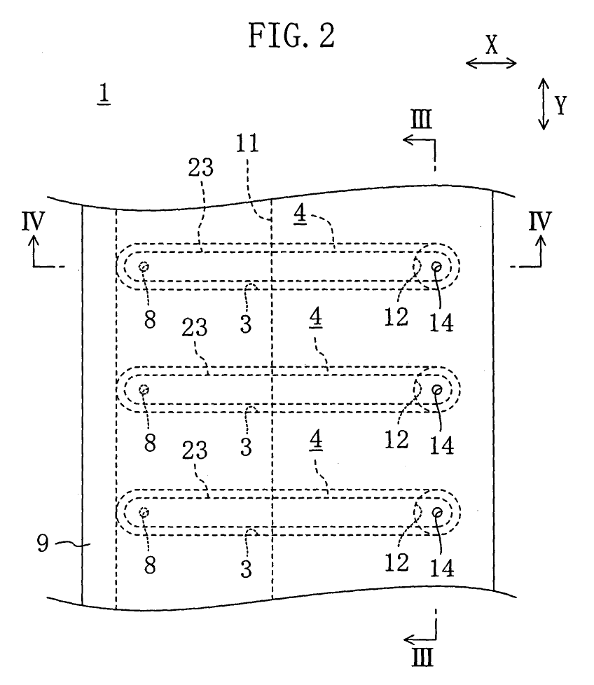

The inkjet head 1 is fixedly supported by a carriage 31. The carriage 31 is provided with a carriage motor (not shown). The inkjet head 1 and the carriage 31 are reciprocated by the carriage motor along a major scanning direction (X direction in FIGS. 1 and 2) while being guided by a carriage shaft 32 that extends along the major scanning direction.

The recording paper 41 is sandwiched by two transfer rollers 42 which are rotated by a transfer motor (not shown). Under the inkjet head 1, the recording paper 41 is transferred by the transfer motor and transfer rollers 42 along the minor scanning direction which is perpendicular to the major scanning direction (Y direction in FIGS. 1 and 2).

As described above, the recording apparatus A is structured such that the inkjet head 1 and the recording paper 41 are relatively moved with respect to each other by the carriage 31, the carriage shaft 32 and the carriage motor, and the transfer rollers 42 and the transfer motor.

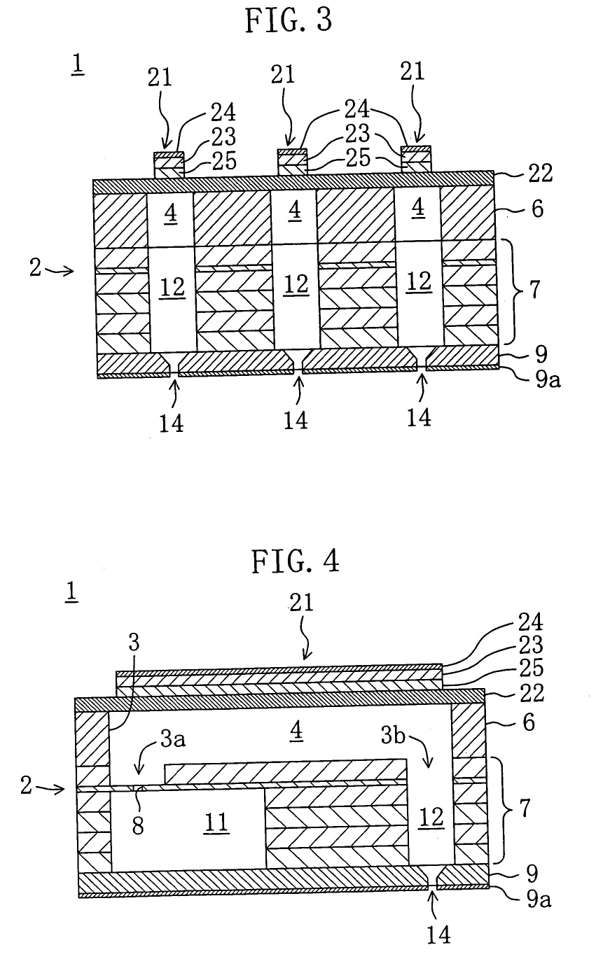

Referring to FIGS. 2 through 4, the inkjet head 1 includes a head main body 2. The head main body 2 has a plurality of concaved portions 3 for pressure rooms.

Each of the concaved portions 3 of the head main body 2 has a supply hole 3a for supplying ink and an ejection hole 3b for ejecting the ink. The concaved portions 3 are opened in the upper surface of the head main body 2 such that the openings extend along the major scanning direction, and arranged along the minor scanning direction with generally-equal intervals therebetween. The length of the opening of each concaved portion 3 is set to about 1250 μm, and the width thereof is set to about 130 μm. Opposite ends of the opening of each concaved portion 3 have a generally-semicircular shape.

A side wall of each concaved portion 3 is formed by a pressure room member 6 made of photosensitive glass having a thickness of about 200 μm. A bottom wall of each concaved portion 3 is formed by an ink passage-member 7 which is adhesively fixed onto the lower surface of the pressure room member 6. The ink passage member 7 is a laminate of six thin plates of stainless steel. The ink passage member 7 has a plurality of orifices 8, one ink supply passage 11, and a plurality of ink ejection passages 12. Each of the orifices 8 is connected to the supply hole 3a of a corresponding one of the concaved portions 3. The ink supply passage 11 extends along the minor scanning direction and is connected to the orifices 8. Each of the ink ejection passages 12 is connected to the ejection hole 3b of a corresponding one of the concaved portions 3.

Each orifice 8 is formed in the thin stainless steel plate which is the second from the top of the ink passage member 7, and whose thickness is smaller than the others.

The diameter of the orifice 8 is set to about 38 μm. The ink supply passage 11 is connected to the ink cartridge 35, such that the ink is supplied from the ink cartridge 35 into the ink supply passage 11.

A nozzle plate 9 made of stainless steel is adhesively fixed onto the lower surface of the ink passage member 7. The nozzle plate 9 has a plurality of nozzles 14 for ejecting ink drops toward the recording paper 41. The lower surface of the nozzle plate 9 is covered with a water-repulsive film 9a. The nozzles 14 are aligned in a row on the lower surface of the inkjet head 1 along the minor scanning direction. The nozzles 14 are connected to the ink ejection passages 12 so as to have a communication with the ejection holes 3b of the concaved portions 3 through the ink ejection passages 12. Each nozzle 14 includes a tapered portion, where the nozzle diameter gradually decreases along a direction toward a nozzle tip side, and a straight portion provided at the nozzle tip side of the tapered portion. The nozzle diameter of the straight portion is set to about 20 μm.

Piezoelectric actuators 21 are provided above the concaved portions 3 of the head main body 2. Each of the piezoelectric actuators 21 has a diaphragm 22 made of Cr. The diaphragm 22 is adhesively fixed onto the upper surface of the head main body 2 so as to cover the concaved portions 3 of the head main body 2, such that the diaphragm 22 and the concaved portions 3 form pressure rooms 4. The diaphragm 22 is made of a single plate which is commonly used for all of the actuators 21. The diaphragm 22 also functions as a common electrode which is commonly used for all of piezoelectric elements 23 (described later).

Each piezoelectric actuator 21 has a piezoelectric element 23 made of lead zirconate titanate (PZT) and an individual electrode 24 made of Pt. On a surface of the diaphragm 22 which is opposite to the pressure room 4 (i.e., the upper surface of the diaphragm 22), an intermediate layer 25 made of Cu is provided at a portion of the surface which corresponds to the pressure room 4 (a portion above the opening of the concaved portion 3), and the piezoelectric element 23 is provided on the intermediate layer 25. The individual electrode 24 is bonded onto a surface of the piezoelectric element 23 which is opposite to the diaphragm 22 (i.e., the upper surface of the piezoelectric element 23). Each individual electrode 24 functions together with the diaphragm 22 to apply a voltage (driving voltage) to a corresponding one of the piezoelectric elements 23.

All of the diaphragm 22, the piezoelectric elements 23, the individual electrodes 24 and the intermediate layers 25 are formed of thin films. The thickness of the diaphragm 22 is set to about 6 μm. The thickness of each piezoelectric element 23 is set to 8 μm or smaller (e.g., about 3 μm). The thickness of each individual electrode 24 is set to about 0.2 μm. The thickness of each intermediate layer 25 is set to about 3 μm.

Each piezoelectric actuator 21 applies a driving voltage to the piezoelectric element 23 through the diaphragm 22 and the individual electrode 24, thereby deforming a portion of the diaphragm 22 which corresponds to the pressure room 4 (a portion of the diaphragm 22 at the opening of the concaved portion 3). As a result of the deformation of the diaphragm 22, the ink in the pressure room 4 is ejected from the nozzle 14 through the ejection hole 3b. That is, when a pulse-shaped voltage is applied between the diaphragm 22 and the individual electrode 24, the piezoelectric element 23 shrinks in the width direction of the piezoelectric element 23, which is perpendicular to the thickness direction thereof, in response to a rising edge of the pulse voltage because of a piezoelectric effect. On the other hand, the diaphragm 22, the individual electrode 24 and the intermediate layer 25 do not shrink even when the pulse voltage is applied. As a result, a portion of the diaphragm 22 which corresponds to the pressure room 4 is flexibly deformed into the shape of a convex toward the pressure room 4 because of a so-called bimetal effect. This flexible deformation increases the pressure inside the pressure room 4, and because of this increased pressure, the ink in the pressure room 4 is extruded out of the nozzle 14 through the ejection hole 3b and the ink ejection passages 12. Then, the piezoelectric element 23 expands in response to a falling edge of the pulse voltage so that the portion of the diaphragm 22 which corresponds to the pressure room 4 recovers its original shape. At this time, the ink extruded out of the nozzle 14 is separated from the ink remaining in the ink ejection passage 12, whereby the separated ink is released as an ink drop (e.g., 3 μm) toward the recording paper 41. The released ink drop adheres onto the recording paper 41 in the form of a dot. On the other hand, when the diaphragm 22 flexibly deformed in the shape of a convex recovers its original shape, the pressure room 4 is charged with ink supplied from the ink cartridge 35 through the ink supply passage 11 and the supply hole 3a. The pulse voltage applied to the piezoelectric elements 23 is not limited to the voltage of push-up/pull-down type as described above, but may be a voltage of pull-down/push-up type which falls from the first voltage to the second voltage that is lower than the first voltage and then rises to the first voltage.

The application of the driving voltage to each piezoelectric element 23 is performed at a predetermined time interval (for example, about 50 μm: driving frequency=20 kHz) while the inkjet head 1 and the carriage 31 are moved from one edge to the other edge of the recording paper 41 at a generally uniform speed along the major scanning direction. It should be noted, however, that the voltage is not applied when the inkjet head 1 resides above a portion of the recording paper 41 where an ink drop is not to be placed. In this way, an ink drop is placed at a predetermined position. After recording of one scanning cycle completes, the recording paper 41 is transferred by a predetermined distance along the minor scanning direction by the transfer motor and the transfer rollers 42. Then, ink drops are ejected again while the inkjet head 1 and the carriage 31 are moved along the major scanning direction, whereby recording of another one scanning cycle is performed. This operation is repeated until a desired image is formed over the recording paper 41.

Ink Composition

An ink composition used in the recording apparatus A contains a colorant, a humectant for suppressing drying of the ink composition in the nozzle 14 of the inkjet head 1, or the like, a penetrant for enhancing the permeability of the ink composition (solvent) into the recording paper 41, water, and a water-soluble substance that is condensation-polymerized in the absence of the water.

The dye may be any type of dye but is preferably a water-soluble acid dye or direct dye.

Preferable pigments are shown below. For example, preferable black pigments include carbon black whose surface is treated with a diazonium salt and carbon black whose surface is treated by graft polymerization of a polymer.

Preferable color pigments include a pigment treated with a surface active agent, such as a formalin condensation product of naphthalene sulfonate, lignin sulfonic acid, dioctylsulfosuccinate, polyoxyethylene alkylamine, aliphatic acid ester, or the like. Specifically, examples of preferable cyan pigments include Pigment Blue 15:3, Pigment Blue 15:4, and aluminum phthalocyanine. Examples of preferable magenta pigments include Pigment Red 122 and Pigment Violet 19. Examples of preferable yellow pigments include Pigment Yellow 74, Pigment Yellow 109, Pigment Yellow 110, and Pigment Yellow 128.

The humectant is desirably a polyhydric alcohol, such as glycerol, 1,3-butanediol, or the like, or a water-soluble nitrogen heterocyclic compound, such as 2-pyrrolidone or N-methyl-2-pyrrolidone.

The penetrant is preferably monoalkylether of polyhydric alcohol, such as diethyleneglycol monobutylether, 2-butoxyethanol, or the like.

When a drop of the ink ejected from the nozzle 14 of the inkjet head 1 is adhered on the recording paper 41, and a water content (solvent) of the ink drop evaporates or permeates into the recording paper 41, the water-soluble substance is condensation-polymerized on the recording paper 41 to enclose a colorant of the ink. As a result, even when the image formed on the recording paper 41 is exposed to water, the colorant is prevented from exuding into the water. In this way, the water-resistivity of the image is improved. Specific examples of the water-soluble substance having such a function include hydrolyzable silane compounds, hydrolyzable titan compounds, and the like. Among these compounds, a hydrolyzable silane compound is especially preferable in consideration of dissolution stability.

The water-soluble substance used in the present embodiment has a hydrophobic group. Examples of the hydrophobic group include a fluoroalkyl group and an alkyl group.

Preferable examples of the hydrolyzable silane compound (organic silicon compound) having a fluoroalkyl group includes the followings: a reaction product of hydrolysis (hydrolyzate) of an alkoxysilane containing an organic group that has an amino group, a fluoroalkylalkoxysilane and an alkoxysilane not containing an amino group; and an organic silicon compound obtained by hydrolysis of a hydrolyzable silane that is produced by reacting an organic monoepoxy compound with a hydrolyzable silane having an amino group, a fluoroalkylalkoxysilane and a hydrolyzable silane not containing a nitrogen atom.

Examples of the fluoroalkylalkoxysilane include the compounds of Chemical Formula 1 to Chemical Formula 4 shown below.

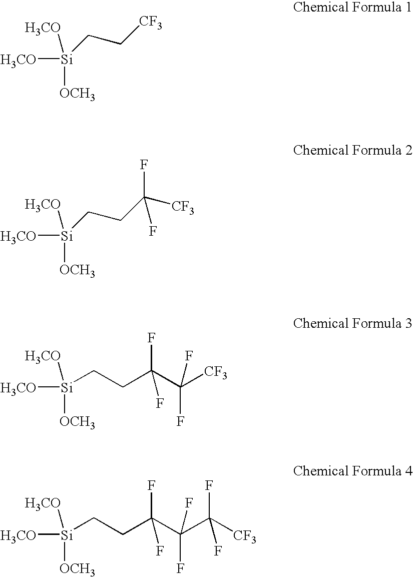

Preferable examples of the hydrolyzable silane compound (organic silicon compound) having an alkyl group includes the followings: a reaction product of hydrolysis (hydrolyzate) of an alkoxysilane containing an organic group that has an amino group, an alkylalkoxysilane and an alkoxysilane not containing an amino group; and an organic silicon compound obtained by hydrolysis of a hydrolyzable silane that is produced by reacting an organic monoepoxy compound with a hydrolyzable silane having an amino group, an alkylalkoxysilane and a hydrolyzable silane not containing a nitrogen atom.

The carbon number of the alkyl group is preferably equal to or greater than 3 and equal to or smaller than 6. This is because the solubility of the silane compound in water deteriorates when the carbon number of the alkyl group is 7 or greater.

Examples of the alkylalkoxysilane include the compounds of Chemical Formula 5 to Chemical Formula 12 shown below.

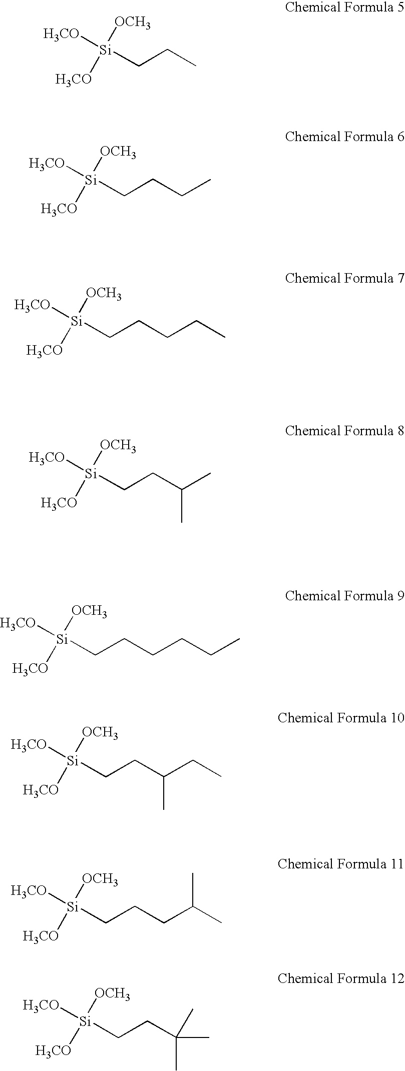

The hydrophobic group(s) of the silane compound may include both a fluoroalkyl group and an alkyl group.

In the present invention, an ink composition includes a colorant, a humectant, a penetrant, water, and a hydrolyzable silane compound which is a water-soluble substance that is condensation-polymerized in the absence of the water. In the case where this ink composition is used to form an image on the recording paper 41 with the recording apparatus A, a solvent containing the humectant, the penetrant and the water permeates into the recording paper 41 when an ink drop is adhered on the recording paper 41. Accordingly, the silane compound is condensation-polymerized, and the condensation-polymerized silane compound encloses the colorant. Thus, even when the image formed on the recording paper 41 is exposed to water, the colorant is prevented from exuding into the water.

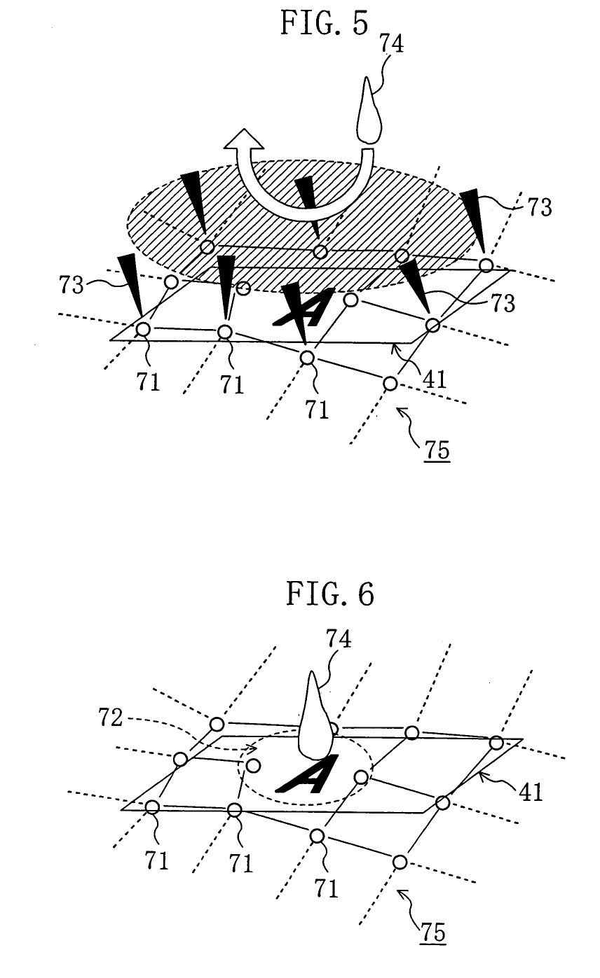

In the ink composition of the present embodiment, the silane compound has a hydrophobic group(s). With this feature, the water-resistivity of the ink composition is greatly improved. That is, as shown in FIG. 5, the network 75 formed by bonding of the silicon atoms 71 encloses an image (colorant) formed on the recording paper 41. Since the silane compound has hydrophobic groups 73, the network 75 has hydrophobicity (i.e., repellency). Thus, the network 75 is impervious to water 74 (see the hatched area in FIG. 5). Therefore, even when the network 75 has a defective portion 72 (FIG. 6), the colorant enclosed by the network 75 is prevented from exuding through the defective portion 72. As a result, the water-resistivity of the image is greatly improved.

As described above, the defective portion 72 is readily formed in the network 75 when the colorant is a magenta dye (acid dye). However, even when the colorant is a magenta dye, sufficient water-resistivity is obtained by making the network 75 hydrophobic. As a matter of course, sufficient water-resistivity is also obtained when the colorant is a dye other than the magenta dye and when the colorant is a pigment.

Especially when the hydrophobic group is a fluoroalkyl group, the surface tension of the ink composition is significantly low. As a result, the rate of diffusion of an ink drop adhered on the recording paper 41 into the recording paper 41 increases, and the rapid-drying property of the ink improves.

In the present embodiment, the ink composition contains a hydrolyzable silane compound as the water-soluble substance that is condensation-polymerized in the absence of water, but the water-soluble substance is not limited thereto. Any type of water-soluble substance may be used so long as the substance is condensation-polymerized to enclose a colorant of ink when an ink drop ejected from the nozzle 14 of the inkjet head 1 is adhered on the recording paper 41 and the water content (solvent) of the ink drop evaporates or permeates into the recording paper 41.

Furthermore, in the present embodiment, the ink composition contains a penetrant. However, the penetrant is not an indispensable constituent of the ink composition of the present embodiment. It should be noted, however, that in the case of using the ink composition containing a penetrant, the solvent of the ink permeates into the recording paper 41 more quickly, and as a result, the water-resistivity of an image formed with the ink is further improved.

Next, specific examples of the present embodiment are described below.

First, 51 types of ink compositions for inkjet recording, which have the constituents shown below, were prepared (Examples 1 to 51). (It should be noted that the contents of the constituents of each composition are shown in percentage by mass.) All of the ink compositions of Examples 1 to 51 contain glycerol as a humectant.

In all the ink compositions of Examples 1 to 51, a dye is contained as a colorant. The dye used is C.I. Acid Black 2, except for Examples 13 to 15 and 36 to 38. The ink compositions of Examples 13 to 15 and 36 to 38 contain dyes of different colors.

Each of the ink compositions of Examples 1 to 51 contains an organic silicon compound as the water-soluble substance that is condensation-polymerized in the absence of water.

### EXAMPLE 1

Organic silicon compound (A1) contained in the ink composition of Example 1 was prepared by the following method. First, 340 g (18.9 mol) of water was poured into a reactor. A mixture of 100 g (0.56 mol) of H₂NCH₂CH₂CH₂Si(OCH₃)₃, 15.3 (0.07 mol) of fluoroalkylalkoxysilane represented by Chemical Formula 1 and 32.0 g (0.21 10 mol) of Si(OCH₃)₄ was then added to the water in a drop-by-drop fashion. After all of the mixture was dropped into the reactor, the temperature of the reactor was increased to 60° C., and the stirring was continued for one hour. A resultant product of this process was organic silicon compound (A1), which was contained in the ink composition of Example 1.

| | |
|---|---|
| C.I. Acid Black 2 | 5% |
| glycerol | 10% |
| diethylene glycol | 7% |
| organic silicon compound (A1) | 10% |
| pure water | 68% |

### EXAMPLE 2

Organic silicon compound (A2) contained in the ink composition of Example 2 was prepared by the same production method as that employed for organic silicon compound (A1) of Example 1 except that 18.8 g (0.07 mol) of fluoroalkylalkoxysilane represented by Chemical Formula 2 was used in place of the 25 fluoroalkylalkoxysilane represented by Chemical Formula 1 in Example 1.

| | |
|---|---|
| C.I. Acid Black 2 | 5% |
| glycerol | 10% |
| diethylene glycol | 7% |
| organic silicon compound (A2) | 10% |
| pure water | 68% |

### EXAMPLE 3

Organic silicon compound (A3) contained in the ink composition of Example 3 was prepared by the same production method as that employed for organic silicon compound (A1) of Example 1 except that 22.3 g (0.07 mol) of fluoroalkylalkoxysilane represented by Chemical Formula 3 was used in place of the fluoroalkylalkoxysilane represented by Chemical Formula 1 in Example 1.

| | |
|---|---|
| C.I. Acid Black 2 | 5% |
| glycerol | 10% |
| diethylene glycol | 7% |
| organic silicon compound (A3) | 10% |
| pure water | 68% |

### EXAMPLE 4

Organic silicon compound (A4) contained in the ink composition of Example 4 was prepared by the same production method as that employed for organic silicon compound (A1) of Example 1 except that 25.8 g (0.07 mol) of fluoroalkylalkoxysilane represented by Chemical Formula 4 was used in place of the fluoroalkylalkoxysilane represented by Chemical Formula 1 in Example 1.

| | |
|---|---|
| C.I. Acid Black 2 | 5% |
| glycerol | 10% |
| diethylene glycol | 7% |
| organic silicon compound (A4) | 10% |
| pure water | 68% |

### EXAMPLE 5

The ink composition of Example 5 contains diethyleneglycol monobutylether as a penetrant in addition to the constituents of the ink composition of Example 1.

| | |
|---|---|
| C.I. Acid Black 2 | 5% |
| glycerol | 10% |
| diethyleneglycol monobutylether | 5% |
| diethylene glycol | 7% |
| organic silicon compound (A1) | 10% |
| pure water | 63% |

### EXAMPLE 6

The ink composition of Example 6 contains diethyleneglycol monobutylether as a penetrant in addition to the constituents of the ink composition of Example 2.

| | |
|---|---|
| C.I. Acid Black 2 | 5% |
| glycerol | 10% |
| diethyleneglycol monobutylether | 5% |
| diethylene glycol | 7% |
| organic silicon compound (A2) | 10% |
| pure water | 63% |

### EXAMPLE 7

The ink composition of Example 7 contains diethyleneglycol monobutylether as a penetrant in addition to the constituents of the ink composition of Example 3.

| | |
|---|---|
| C.I. Acid Black 2 | 5% |
| glycerol | 10% |
| diethyleneglycol monobutylether | 5% |
| diethylene glycol | 7% |
| organic silicon compound (A3) | 10% |
| pure water | 63% |

### EXAMPLE 8

The ink composition of Example 8 contains diethyleneglycol monobutylether as a penetrant in addition to the constituents of the ink composition of Example 4.

| | |
|---|---|
| C.I. Acid Black 2 | 5% |
| glycerol | 10% |
| diethyleneglycol monobutylether | 5% |
| diethylene glycol | 7% |
| organic silicon compound (A4) | 10% |
| pure water | 63% |

### EXAMPLE 9

Organic silicon compound (C1) contained in the ink composition of Example 9 was prepared by the following method. First, 100 g (0.56 mol) of H₂NCH₂CH₂CH₂Si(OCH₃)₃ was provided into a reactor. Then, 49 g (0.66 mol) of 2,3-epoxy-1-propanol was added into the reactor in a drop-by-drop fashion. After all of 2,3epoxy-1-propanol was dropped into the reactor, the temperature of the reactor was increased to 80° C., and a resultant mixture in the reactor was stirred for 5 hours, whereby an amino group and an epoxy group were reacted to obtain hydrolyzable silane (B1). Thereafter, 340 g (18.9 mol) of water was poured into another reactor, and a mixture of 142.0 g (0.56 mol) of hydrolyzable silane (B1), 15.3 g (0.07 mol) of fluoroalkylalkoxysilane represented by Chemical Formula 1 and 32.0 g (0.21 mol) of Si(OCH₃)₄ was added to the water in the reactor in a drop-by-drop fashion. After all of the mixture was dropped into the reactor, the temperature of the reactor was increased to 60° C., and the content in the reactor was subjected to a reaction for one hour. A resultant product of the reaction was organic silicon compound (C1), which was contained in the ink composition of Example 9.

| | |
|---|---|
| C.I. Acid Black 2 | 5% |
| glycerol | 10% |
| diethyleneglycol monobutylether | 5% |
| diethylene glycol | 7% |
| organic silicon compound (C1) | 10% |
| pure water | 63% |

### EXAMPLE 10

Organic silicon compound (C2) contained in the ink composition of Example 10 was prepared by the same production method as that employed for organic silicon compound (C1) of Example 9 except that 18.8 g (0.07 mol) of fluoroalkylalkoxysilane represented by Chemical Formula 2 was used in place of the fluoroalkylalkoxysilane represented by Chemical Formula 1 in Example 9.

| | |
|---|---|
| C.I. Acid Black 2 | 5% |
| glycerol | 10% |
| diethyleneglycol monobutylether | 5% |
| diethylene glycol | 7% |
| organic silicon compound (C2) | 10% |
| pure water | 63% |

### EXAMPLE 11

Organic silicon compound (C3) contained in the ink composition of Example 11 was prepared by the same production method as that employed for organic silicon compound (C1) of Example 9 except that 22.3 g (0.07 mol) of fluoroalkylalkoxysilane represented by Chemical Formula 3 was used in place of the fluoroalkylalkoxysilane represented by Chemical Formula 1 in Example 9.

| | |
|---|---|
| C.I. Acid Black 2 | 5% |
| glycerol | 10% |
| diethyleneglycol monobutylether | 5% |
| diethylene glycol | 7% |
| organic silicon compound (C3) | 10% |
| pure water | 63% |

### EXAMPLE 12

Organic silicon compound (C4) contained in the ink composition of Example 12 was prepared by the same production method as that employed for organic silicon compound (C1) of Example 9 except that 25.8 g (0.07 mol) of fluoroalkylalkoxysilane represented by Chemical Formula 4 was used in place of the fluoroalkylalkoxysilane represented by Chemical Formula 1 in Example 9.

| | |
|---|---|
| C.I. Acid Black 2 | 5% |
| glycerol | 10% |
| diethyleneglycol monobutylether | 5% |
| diethylene glycol | 7% |
| organic silicon compound (C4) | 10% |
| pure water | 63% |

### EXAMPLE 13

The ink composition of Example 13 has the same constituents as those of the ink composition of Example 5 except that C.I. Direct Yellow 86 was used in place of C.I. Acid Black 2.

| | |
|---|---|
| C.I. Direct Yellow 86 | 5% |
| glycerol | 10% |
| diethyleneglycol monobutylether | 5% |
| diethylene glycol | 7% |
| organic silicon compound (A1) | 10% |
| pure water | 63% |

### EXAMPLE 14

The ink composition of Example 14 has the same constituents as those of the ink composition of Example 5 except that C.I. Acid Red 52 was used in place of C.I. Acid Black 2.

| | |
|---|---|
| C.I. Acid Red 52 | 5% |
| glycerol | 10% |
| diethyleneglycol monobutylether | 5% |
| diethylene glycol | 7% |
| organic silicon compound (A1) | 10% |
| pure water | 63% |

### EXAMPLE 15

The ink composition of Example 15 has the same constituents as those of the ink composition of Example 5 except that C.I. Direct Blue 86 was used in place of C.I. Acid Black 2.

| | |
|---|---|
| C.I. Direct Blue 86 | 5% |
| glycerol | 10% |
| diethyleneglycol monobutylether | 5% |
| diethylene glycol | 7% |
| organic silicon compound (A1) | 10% |
| pure water | 63% |

### EXAMPLE 16

Organic silicon compound (A5) contained in the ink composition of Example 16 was prepared by the same production method as that employed for organic silicon compound (A1) of Example 1, except that the amount of the fluoroalkylalkoxysilane represented by Chemical Formula 1 was changed from 15.3 g (0.07 mol) to 30.6 g (0.14 mol), and the amount of Si(OCH₃)₄ was changed from 32.0 g (0.21 mol) to 21.3 g (0.14 mol). Further, diethyleneglycol monobutylether was added as a penetrant.

| | |
|---|---|
| C.I. Acid Black 2 | 5% |
| glycerol | 10% |
| diethyleneglycol monobutylether | 5% |
| diethylene glycol | 7% |
| organic silicon compound (A5) | 10% |
| pure water | 63% |

### EXAMPLE 17

Organic silicon compound (A6) contained in the ink composition of Example 17 was prepared by the same production method as that employed for organic silicon compound (A1) of Example 1, except that the amount of the fluoroalkylalkoxysilane represented by Chemical Formula 1 was changed from 15.3 g (0.07 mol) to 17.5 g (0.08 mol), and the amount of Si(OCH₃)₄ was changed from 32.0 g (0.21 mol) to 30.5 g (0.2 mol). Further, diethyleneglycol monobutylether was added as a penetrant.

| | |
|---|---|
| C.I. Acid Black 2 | 5% |
| glycerol | 10% |
| diethyleneglycol monobutylether | 5% |
| diethylene glycol | 7% |
| organic silicon compound (A6) | 10% |
| pure water | 63% |

### EXAMPLE 18

Organic silicon compound (A7) contained in the ink composition of Example 18 was prepared by the same production method as that employed for organic silicon compound (A1) of Example 1, except that the amount of the fluoroalkylalkoxysilane represented by Chemical Formula 1 was changed from 15.3 g (0.07 mol) to 13.1 g (0.06 mol), and the amount of Si(OCH₃)₄ was changed from 32.0 g (0.21 mol) to 33.5 g (0.22 mol). Further, diethyleneglycol monobutylether was added as a penetrant.

| | |
|---|---|
| C.I. Acid Black 2 | 5% |
| glycerol | 10% |
| diethyleneglycol monobutylether | 5% |
| diethylene glycol | 7% |
| organic silicon compound (A7) | 10% |
| pure water | 63% |

### EXAMPLE 19

Organic silicon compound (A8) contained in the ink composition of Example 18 was prepared by the same production method as that employed for organic silicon compound (A1) of Example 1, except that the amount of the fluoroalkylalkoxysilane represented by Chemical Formula 1 was changed from 15.3 g (0.07 mol) to 6.6 g (0.03 mol), and the amount of Si(OCH,)₄ was changed from 32.0 g (0.21 mol) to 38.1 g (0.25 mol). Further, diethyleneglycol monobutylether was added as a penetrant.

| | |
|---|---|
| C.I. Acid Black 2 | 5% |
| glycerol | 10% |
| diethyleneglycol monobutylether | 5% |
| diethylene glycol | 7% |
| organic silicon compound (A8) | 10% |
| pure water | 63% |

### EXAMPLE 20

Organic silicon compound (A9) contained in the ink composition of Example 20 was prepared by the same production method as that employed for organic silicon compound (A1) of Example 1 except that 11.5 g (0.07 mol) of alkylalkoxysilane represented by Chemical Formula 5 was used in place of the fluoroalkylalkoxysilane represented by Chemical Formula 1 in Example 1.

| | |
|---|---|
| C.I. Acid Black 2 | 5% |
| glycerol | 10% |
| diethylene glycol | 7% |
| organic silicon compound (A9) | 10% |
| pure water | 68% |

### EXAMPLE 21

Organic silicon compound (A10) contained in the ink composition of Example 21 was prepared by the same production method as that employed for organic silicon compound (A1) of Example 1 except that 12.5 g (0.07 mol) of alkylalkoxysilane represented by Chemical Formula 6 was used in place of the fluoroalkylalkoxysilane represented by Chemical Formula 1 in Example 1.

| | |
|---|---|
| C.I. Acid Black 2 | 5% |
| glycerol | 10% |
| diethylene glycol | 7% |
| organic silicon compound (A10) | 10% |
| pure water | 68% |

### EXAMPLE 22

Organic silicon compound (A11) contained in the ink composition of Example 22 was prepared by the same production method as that employed for organic silicon compound (A1) of Example 1 except that 13.5 g (0.07 mol) of alkylalkoxysilane represented by Chemical Formula 7 was used in place of the fluoroalkylalkoxysilane represented by Chemical Formula 1 in Example 1.

| | |
|---|---|
| C.I. Acid Black 2 | 5% |
| glycerol | 10% |
| diethylene glycol | 7% |
| organic silicon compound (A11) | 10% |
| pure water | 68% |

### EXAMPLE 23

Organic silicon compound (A12) contained in the ink composition of Example 23 was prepared by the same production method as that employed for organic silicon compound (A1) of Example 1 except that 13.5 g (0.07 mol) of alkylalkoxysilane represented by Chemical Formula 8 was used in place of the fluoroalkylalkoxysilane represented by Chemical Formula 1 in Example 1.

| | |
|---|---|
| C.I. Acid Black 2 | 5% |
| glycerol | 10% |
| diethylene glycol | 7% |
| organic silicon compound (A12) | 10% |
| pure water | 68% |

### EXAMPLE 24

Organic silicon compound (A13) contained in the ink composition of Example 24 was prepared by the same production method as that employed for organic silicon compound (A1) of Example 1 except that 14.5 g (0.07 mol) of alkylalkoxysilane represented by Chemical Formula 9 was used in place of the fluoroalkylalkoxysilane represented by Chemical Formula 1 in Example 1.

| | |
|---|---|
| C.I. Acid Black 2 | 5% |
| glycerol | 10% |
| diethylene glycol | 7% |
| organic silicon compound (A13) | 10% |
| pure water | 68% |

### EXAMPLE 25

Organic silicon compound (A14) contained in the ink composition of Example 25 was prepared by the same production method as that employed for organic silicon compound (A1) of Example 1 except that 14.5 g (0.07 mol) of alkylalkoxysilane represented by Chemical Formula 10 was used in place of the fluoroalkylalkoxysilane represented by Chemical Formula 1 in Example 1.

| | |
|---|---|
| C.I. Acid Black 2 | 5% |
| glycerol | 10% |
| diethylene glycol | 7% |
| organic silicon compound (A14) | 10% |
| pure water | 68% |

### EXAMPLE 26

Organic silicon compound (A15) contained in the ink composition of Example 26 was prepared by the same production method as that employed for organic silicon compound (A1) of Example 1 except that 14.5 g (0.07 mol) of alkylalkoxysilane represented by Chemical Formula 11 was used in place of the fluoroalkylalkoxysilane represented by Chemical Formula 1 in Example 1.

| | |
|---|---|
| C.I. Acid Black 2 | 5% |
| glycerol | 10% |
| diethylene glycol | 7% |
| organic silicon compound (A15) | 10% |
| pure water | 68% |

### EXAMPLE 27

Organic silicon compound (A16) contained in the ink composition of Example 27 was prepared by the same production method as that employed for organic silicon compound (A1) of Example 1 except that 14.5 g (0.07 mol) of alkylalkoxysilane represented by Chemical Formula 12 was used in place of the fluoroalkylalkoxysilane represented by Chemical Formula 1 in Example 1.

| | |
|---|---|
| C.I. Acid Black 2 | 5% |
| glycerol | 10% |
| diethylene glycol | 7% |
| organic silicon compound (A16) | 10% |
| pure water | 68% |

### EXAMPLE 28

The ink composition of Example 28 contains diethyleneglycol monobutylether as a penetrant in addition to the constituents of the ink composition of Example 20.

| | |
|---|---|
| C.I. Acid Black 2 | 5% |
| glycerol | 10% |
| diethyleneglycol monobutylether | 5% |
| diethylene glycol | 7% |
| organic silicon compound (A9) | 10% |
| pure water | 63% |

### EXAMPLE 29

The ink composition of Example 29 contains diethyleneglycol monobutylether as a penetrant in addition to the constituents of the ink composition of Example 21.

| | |
|---|---|
| C.I. Acid Black 2 | 5% |
| glycerol | 10% |
| diethyleneglycol monobutylether | 5% |
| diethylene glycol | 7% |
| organic silicon compound (A10) | 10% |
| pure water | 63% |

### EXAMPLE 30

The ink composition of Example 30 contains diethyleneglycol monobutylether as a penetrant in addition to the constituents of the ink composition of Example 22.

| | |
|---|---|
| C.I. Acid Black 2 | 5% |
| glycerol | 10% |
| diethyleneglycol monobutylether | 5% |
| diethylene glycol | 7% |
| organic silicon compound (A11) | 10% |
| pure water | 63% |

### EXAMPLE 31

The ink composition of Example 31 contains diethyleneglycol monobutylether as a penetrant in addition to the constituents of the ink composition of Example 23.

| | |
|---|---|
| C.I. Acid Black 2 | 5% |
| glycerol | 10% |
| diethyleneglycol monobutylether | 5% |
| diethylene glycol | 7% |
| organic silicon compound (A12) | 10% |
| pure water | 63% |

### EXAMPLE 32

The ink composition of Example 32 contains diethyleneglycol monobutylether as a penetrant in addition to the constituents of the ink composition of Example 24.

| | |
|---|---|
| C.I. Acid Black 2 | 5% |
| glycerol | 10% |
| diethyleneglycol monobutylether | 5% |
| diethylene glycol | 7% |
| organic silicon compound (A13) | 10% |
| pure water | 63% |

### EXAMPLE 33

The ink composition of Example 33 contains diethyleneglycol monobutylether as a penetrant in addition to the constituents of the ink composition of Example 25.

| | |
|---|---|
| C.I. Acid Black 2 | 5% |
| glycerol | 10% |
| diethyleneglycol monobutylether | 5% |
| diethylene glycol | 7% |
| organic silicon compound (A14) | 10% |
| pure water | 63% |

### EXAMPLE 34

The ink composition of Example 34 contains diethyleneglycol monobutylether as a penetrant in addition to the constituents of the ink composition of Example 26.

| | |
|---|---|
| C.I. Acid Black 2 | 5% |
| glycerol | 10% |
| diethyleneglycol monobutylether | 5% |
| diethylene glycol | 7% |
| organic silicon compound (A15) | 10% |
| pure water | 63% |

### EXAMPLE 35

The ink composition of Example 35 contains diethyleneglycol monobutylether as a penetrant in addition to the constituents of the ink composition of Example 27.

| | |
|---|---|
| C.I. Acid Black 2 | 5% |
| glycerol | 10% |
| diethyleneglycol monobutylether | 5% |
| diethylene glycol | 7% |
| organic silicon compound (A16) | 10% |
| pure water | 63% |

### EXAMPLE 36

The ink composition of Example 36 has the same constituents as those of the ink composition of Example 28 except that C.I. Direct Yellow 86 was used in place of C.I. Acid Black 2.

| | |
|---|---|
| C.I. Direct Yellow 86 | 5% |
| glycerol | 10% |
| diethyleneglycol monobutylether | 5% |
| diethylene glycol | 7% |
| organic silicon compound (A9) | 10% |
| pure water | 63% |

### EXAMPLE 37

The ink composition of Example 37 has the same constituents as those of the ink composition of Example 28 except that C.I. Acid Red 52 was used in place of C.I. Acid Black 2.

| | |
|---|---|
| C.I. Acid Red 52 | 5% |
| glycerol | 10% |
| diethyleneglycol monobutylether | 5% |
| diethylene glycol | 7% |
| organic silicon compound (A9) | 10% |
| pure water | 63% |

### EXAMPLE 38

The ink composition of Example 38 has the same constituents as those of the ink composition of Example 28 except that C.I. Direct Blue 86 was used in place of C.I. Acid Black 2.

| | |
|---|---|
| C.I. Direct Blue 86 | 5% |
| glycerol | 10% |
| diethyleneglycol monobutylether | 5% |
| diethylene glycol | 7% |
| organic silicon compound (A9) | 10% |
| pure water | 63% |

### EXAMPLE 39

Organic silicon compound (A17) contained in the ink composition of Example 39 was prepared by the same production method as that employed for organic silicon compound (A9) of Example 20, except that the amount of the alkylalkoxysilane represented by Chemical Formula 5 was changed from 11.5 g (0.07 mol) to 23.0 g (0.14 mol), and the amount of Si(OCH₃)₄ was changed from 32.0 g (0.21 mol) to 21.3 g (0.14 mol). Further, diethyleneglycol monobutylether was added as a penetrant.

| | |
|---|---|
| C.I. Acid Black 2 | 5% |
| glycerol | 10% |
| diethyleneglycol monobutylether | 5% |
| diethylene glycol | 7% |
| organic silicon compound (A17) | 10% |
| pure water | 63% |

### EXAMPLE 40

Organic silicon compound (A18) contained in the ink composition of Example 40 was prepared by the same production method as that employed for organic silicon compound (A9) of Example 20, except that the amount of the alkylalkoxysilane represented by Chemical Formula 5 was changed from 11.5 g (0.07 mol) to 13.1 g (0.08 mol), and the amount of Si(OCH₃)₄ was changed from 32.0 g (0.21 mol) to 30.5 g (0.2 mol). Further, diethyleneglycol monobutylether was added as a penetrant.

| | |
|---|---|
| C.I. Acid Black 2 | 5% |
| glycerol | 10% |
| diethyleneglycol monobutylether | 5% |
| diethylene glycol | 7% |
| organic silicon compound (A18) | 10% |
| pure water | 63% |

### EXAMPLE 41

Organic silicon compound (A19) contained in the ink composition of Example 41 was prepared by the same production method as that employed for organic silicon compound (A9) of Example 20, except that the amount of the alkylalkoxysilane represented by Chemical Formula 5 was changed from 11.5 g (0.07 mol) to 9.9 g (0.06 mol), and the amount of Si(OCH₃)₄ was changed from 32.0 g (0.21 mol) to 33.5 g (0.22 mol). Further, diethyleneglycol monobutylether was added as a penetrant.

| | |
|---|---|
| C.I. Acid Black 2 | 5% |
| glycerol | 10% |
| diethyleneglycol monobutylether | 5% |
| diethylene glycol | 7% |
| organic silicon compound (A19) | 10% |
| pure water | 63% |

### EXAMPLE 42

Organic silicon compound (A20) contained in the ink composition of Example 42 was prepared by the same production method as that employed for organic silicon compound (A9) of Example 20, except that the amount of the alkylalkoxysilane represented by Chemical Formula 5 was changed from 11.5 g (0.07 mol) to 4.9 g (0.03 mol), and the amount of Si(OCH₃)₄ was changed from 32.0 g (0.21 mol) to 38.1 g (0.25 mol). Further, diethyleneglycol monobutylether was added as a penetrant.

| | |
|---|---|
| C.I. Acid Black 2 | 5% |
| glycerol | 10% |
| diethyleneglycol monobutylether | 5% |
| diethylene glycol | 7% |
| organic silicon compound (A20) | 10% |
| pure water | 63% |

### EXAMPLE 43

Organic silicon compound (C5) contained in the ink composition of Example 43 was prepared by the following method. First, 100 g (0.56 mol) of H₂NCH₂CH₂CH₂Si(OCH₃)₃ was provided into a reactor. Then, 49 g (0.66 mol) of 2,3-epoxy-1-propanol was added into the reactor in a drop-by-drop fashion. After all of 2,3epoxy-1-propanol was dropped into the reactor, the temperature of the reactor was increased to 80° C., and a resultant mixture in the reactor was stirred for 5 hours, whereby an amino group and an epoxy group were reacted to obtain hydrolyzable silane (B1). Thereafter, 340 g (18.9 mol) of water was poured into another reactor, and a mixture of 142.0 g (0.56 mol) of hydrolyzable silane (B1), 11.5 g (0.07 mol) of alkylalkoxysilane represented by Chemical Formula 5 and 32.0 g (0.21 mol) of Si(OCH₃)₄ was added to the water in the reactor in a drop-by-drop fashion. After all of the mixture was dropped into the reactor, the temperature of the reactor was increased to 60° C., and the content in the reactor was subjected to a reaction for one hour. A resultant product of the reaction was organic silicon compound (C5), which was contained in the ink composition of Example 43.

| | |
|---|---|
| C.I. Acid Black 2 | 5% |
| glycerol | 10% |
| diethyleneglycol monobutylether | 5% |
| diethylene glycol | 7% |
| organic silicon compound (C5) | 10% |
| pure water | 63% |

### EXAMPLE 44

Organic silicon compound (C6) contained in the ink composition of Example 44 was prepared by the same production method as that employed for organic silicon compound (C5) of Example 43 except that 12.5 g (0.07 mol) of alkylalkoxysilane represented by Chemical Formula 6 was used in place of the alkylalkoxysilane represented by Chemical Formula 5 in Example 43.

| | |
|---|---|
| C.I. Acid Black 2 | 5% |
| glycerol | 10% |
| diethyleneglycol monobutylether | 5% |
| diethylene glycol | 7% |
| organic silicon compound (C6) | 10% |
| pure water | 63% |

### EXAMPLE 45

Organic silicon compound (C7) contained in the ink composition of Example 45 was prepared by the same production method as that employed for organic silicon compound (C5) of Example 43 except that 13.5 g (0.07 mol) of alkylalkoxysilane represented by Chemical Formula 7 was used in place of the alkylalkoxysilane represented by Chemical Formula 5 in Example 43.

| | |
|---|---|
| C.I. Acid Black 2 | 5% |
| glycerol | 10% |
| diethyleneglycol monobutylether | 5% |
| diethylene glycol | 7% |
| organic silicon compound (C7) | 10% |
| pure water | 63% |

### EXAMPLE 46

Organic silicon compound (C8) contained in the ink composition of Example 46 was prepared by the same production method as that employed for organic silicon compound (C5) of Example 43 except that 13.5 g (0.07 mol) of alkylalkoxysilane represented by Chemical Formula 8 was used in place of the alkylalkoxysilane represented by Chemical Formula 5 in Example 43.

| | |
|---|---|
| C.I. Acid Black 2 | 5% |
| glycerol | 10% |
| diethyleneglycol monobutylether | 5% |
| diethylene glycol | 7% |
| organic silicon compound (C8) | 10% |
| pure water | 63% |

### EXAMPLE 47

Organic silicon compound (C9) contained in the ink composition of Example 47 was prepared by the same production method as that employed for organic silicon compound (C5) of Example 43 except that 14.4 g (0.07 mol) of alkylalkoxysilane represented by Chemical Formula 9 was used in place of the alkylalkoxysilane represented by Chemical Formula 5 in Example 43.

| | |
|---|---|
| C.I. Acid Black 2 | 5% |
| glycerol | 10% |
| diethyleneglycol monobutylether | 5% |
| diethylene glycol | 7% |
| organic silicon compound (C9) | 10% |
| pure water | 63% |

### EXAMPLE 48

Organic silicon compound (C10) contained in the ink composition of Example 48 was prepared by the same production method as that employed for organic silicon compound (C5) of Example 43 except that 14.4 g (0.07 mol) of alkylalkoxysilane represented by Chemical Formula 10 was used in place of the alkylalkoxysilane represented by Chemical Formula 5 in Example 43.

| | |
|---|---|
| C.I. Acid Black 2 | 5% |
| glycerol | 10% |
| diethyleneglycol monobutylether | 5% |
| diethylene glycol | 7% |
| organic silicon compound (C10) | 10% |
| pure water | 63% |

### EXAMPLE 49

Organic silicon compound (C11) contained in the ink composition of Example 49 was prepared by the same production method as that employed for organic silicon compound (C5) of Example 43 except that 14.4 g (0.07 mol) of alkylalkoxysilane represented by Chemical Formula 11 was used in place of the alkylalkoxysilane represented by Chemical Formula 5 in Example 43.

| | |
|---|---|
| C.I. Acid Black 2 | 5% |
| glycerol | 10% |
| diethyleneglycol monobutylether | 5% |
| diethylene glycol | 7% |
| organic silicon compound (C11) | 10% |
| pure water | 63% |

### EXAMPLE 50

Organic silicon compound (C12) contained in the ink composition of Example 50 was prepared by the same production method as that employed for organic silicon compound (C5) of Example 43 except that 14.4 g (0.07 mol) of alkylalkoxysilane represented by Chemical Formula 12 was used in place of the alkylalkoxysilane represented by Chemical Formula 5 in Example 43.

| | |
|---|---|
| C.I. Acid Black 2 | 5% |
| glycerol | 10% |
| diethyleneglycol monobutylether | 5% |
| diethylene glycol | 7% |
| organic silicon compound (C12) | 10% |
| pure water | 63% |

### EXAMPLE 51

Organic silicon compound (D1) contained in the ink composition of Example 51 was prepared by the following method. First, 340 g (18.9 mol) of water was poured in a reactor. Then, a mixture of 100 g (0.56 mol) of H₂NCH₂CH₂CH₂Si(OCH₃)₃, 7.7 g (0.035 mol) of fluoroalkylalkoxysilane represented by Chemical Formula 1, 5.8 g (0.035 mol) of alkylalkoxysilane represented by Chemical Formula 5 and 32.0 g (0.21 mol) of Si(OCH₃)₄ was added into the reactor in a drop-by-drop fashion at room temperature. After all of the mixture was dropped into the reactor, the temperature of the reactor was increased to 60° C., and the content in the reactor was stirred for one hour. A resultant product of this process was organic silicon compound (D1), which was contained in the ink composition of Example 51.

| | |
|---|---|
| C.I. Acid Black 2 | 5% |
| glycerol | 10% |
| diethylene glycol | 7% |
| organic silicon compound (D1) | 10% |
| pure water | 68% |

On the other hand, two types of ink compositions including the following constituents were prepared for comparison (Comparative Examples 1 and 2). (It should be noted that the contents of the constituents of each composition are shown in percentage by mass.)

### COMPARATIVE EXAMPLE 1

Organic silicon compound (A21) contained in the ink composition of Comparative Example 1 was prepared by the same reaction as that employed for organic silicon compound (A1) of Example 1 except that the fluoroalkylalkoxysilane represented by Chemical Formula 1 was not used.

| | |
|---|---|
| C.I. Acid Black 2 | 5% |
| glycerol | 10% |
| diethylene glycol | 7% |
| organic silicon compound (A21) | 10% |
| pure water | 68% |

### COMPARATIVE EXAMPLE 2

Organic silicon compound (C13) contained in the ink composition of Comparative Example 2 was prepared by the same reaction as that employed for organic silicon compound (C1) of Example 9 except that the fluoroalkylalkoxysilane represented by Chemical Formula 1 was not used.

| | |
|---|---|
| C.I. Acid Black 2 | 5% |
| glycerol | 10% |
| diethylene glycol | 7% |
| organic silicon compound (C13) | 10% |
| pure water | 68% |

The water-resistivity test was then performed on the ink compositions of Examples 1-51 and Comparative Examples 1 and 2. An image used in this water-resistivity test was formed using each of the ink compositions of Examples 1-51 and Comparative Examples 1 and 2 on plain paper (product name: “Xerox4024”; produced by Xerox Co.) with a commercially-available printer (which ejects the ink composition using a piezoelectric actuator similar to that of the above-described recording apparatus (except that the thickness of a piezoelectric element is much greater than that of the above-described recording apparatus)). Immediately after the image was formed, the paper was soaked in pure water and then dried in air at room temperature. Then, the degree of a bleeding in the image on the paper was evaluated. Results of the evaluation were shown in Table 1. In Table 1, the symbol of “◯” indicates that a bleeding was not generated, and the symbol of “X” indicates that a bleeding was generated.

TABLE 1

| | | Water- | | Water- | | Water- | | Water- |
|---|---|---|---|---|---|---|---|---|
| | | resis- | | resis- | | resis- | | resis- |
| | | tivity | | tivity | | tivity | | tivity |
| Examples | 1 | ◯ | 16 | ◯ | 31 | ◯ | 46 | ◯ |
| | 2 | ◯ | 17 | ◯ | 32 | ◯ | 47 | ◯ |
| | 3 | ◯ | 18 | ◯ | 33 | ◯ | 48 | ◯ |
| | 4 | ◯ | 19 | ◯ | 34 | ◯ | 49 | ◯ |
| | 5 | ◯ | 20 | ◯ | 35 | ◯ | 50 | ◯ |
| | 6 | ◯ | 21 | ◯ | 36 | ◯ | 51 | ◯ |
| | 7 | ◯ | 22 | ◯ | 37 | ◯ | | |
| | 8 | ◯ | 23 | ◯ | 38 | ◯ | | |
| | 9 | ◯ | 24 | ◯ | 39 | ◯ | | |
| | 10 | ◯ | 25 | ◯ | 40 | ◯ | | |
| | 11 | ◯ | 26 | ◯ | 41 | ◯ | | |
| | 12 | ◯ | 27 | ◯ | 42 | ◯ | | |
| | 13 | ◯ | 28 | ◯ | 43 | ◯ | | |
| | 14 | ◯ | 29 | ◯ | 44 | ◯ | | |
| | 15 | ◯ | 30 | ◯ | 45 | ◯ | | |
| Compara- | 1 | X | | | | | | |
| tive | 2 | X | | | | | | |
| Examples | | | | | | | | |

As seen from the results shown in Table 1, in the images formed with the ink compositions of Comparative Examples 1 and 2, a bleeding was generated. On the other hand, in the images formed with the ink compositions of Examples 1-51, a bleeding was not guaranteed. Thus, it is appreciated that the images formed with the ink composition of Examples 1-51 have sufficient water-resistivity.

Furthermore, it was confirmed that the same results were obtained even when a pigment was used in place of the dye in each of the ink compositions of Examples 1-51.

What is claimed is:

1. An ink composition used for inkjet recording, comprising a colorant, a humectant, water, and a water-soluble substance that is condensation-polymerized in the absence of the water,
wherein the water-soluble substance has a hydrophobic group.

2. The ink composition of claim 1, wherein the water-soluble substance is a hydrolyzate of an amino silane compound and a silicon compound having a hydrophobic group.

3. The ink composition of claim 1, wherein the hydrophobic group is an alkyl group.

4. The ink composition of claim 3, wherein the carbon number of the alkyl group is equal to or greater than 3 and equal to or smaller than 6.

5. The ink composition of claim 1, wherein the hydrophobic group is a fluoroalkyl group.

6. The ink composition of claim 1, wherein the hydrophobic group includes both an alkyl group and a fluoroalkyl group.

7. The ink composition of claim 6, wherein the carbon number of the alkyl group is equal to or greater than 3 and equal to or smaller than 6.

8. The ink composition of claim 1, further comprising a penetrant.

9. The ink composition of claim 2, wherein the amount of the silicon compound having a hydrophobic group is equal to or higher than 3 mol % and equal to or lower than 17 mol % when calculated on the basis of a silicon atom as a reference.

10. An ink cartridge comprising an ink composition for inkjet recording, wherein:
the ink composition contains a colorant, a humectant, water, and a water-soluble substance that is condensation-polymerized in the absence of the water; and
the water-soluble substance has a hydrophobic group.

11. The ink cartridge of claim 10, wherein the ink composition further contains a penetrant.

12. A recording apparatus comprising an ink composition for inkjet recording, the recording apparatus ejecting the ink composition toward a recording medium, wherein:
the ink composition contains a colorant, a humectant, water, and a water-soluble substance that is condensation-polymerized in the absence of the water; and
the water-soluble substance has a hydrophobic group.

13. The recording apparatus of claim 12, wherein the ink composition further contains a penetrant.
